(19) United States
(12) Patent Application Publication
(10) Pub. No.: US 2015/0054349 A1
(43) Pub. Date: Feb. 26, 2015

(54) WIRELESS POWER SUPPLY DEVICE

(71) Applicant: Keio University, Tokyo (JP)

(72) Inventors: Hiroki Ishikuro, Kanagawa (JP); Tadahiro Kuroda, Kanagawa (JP); Masao Taguchi, Kanagawa (JP)

(21) Appl. No.: 14/379,244

(22) PCT Filed: Feb. 4, 2013
(86) PCT No.: PCT/JP2013/052437

§ 371 Date: Aug. 15, 2014

(30) Foreign Application Priority Data
Feb. 17, 2012 (JP) 2012-033264

(51) Int. Cl. H01F 38/14; H02J 5/00

(52) U.S. Cl. CPC H01F 38/14; H02J 5/005
USPC 307/104

(57) ABSTRACT

Wirelessly supplying power is rapidly changed by a switching circuit 11 selectively exciting a magnetic field coupling resonance circuit of L1 and C1 for wireless power supply by use of a resonant frequency of the resonance circuit and its ⅓-divided frequency. A large power is supplied in the case of excitation at the resonant frequency, and in the case of excitation at the ⅓-divided frequency, a small power is supplied. A wireless power supply device with a high power conversion efficiency, with less unwanted radiation, and capable of rapidly changing supplying power can thereby be provided.

### TECHNICAL FIELD

The present invention relates to a wireless power supply device which wirelessly transfers power to, for example, an information processing and accumulation device without a power source such as a memory card, and particularly, to a wireless power supply device capable of increasing the response speed to a load fluctuation, increasing the power conversion efficiency, and reducing unwanted radiation.

### BACKGROUND ART

Wireless power supply, which is to transfers power via no metal contact or connector, has therefore been adopted for applications in which water resistance is required and/or applications in which exposure of terminals is not preferred, such as, for example, a non-contact IC card, a cordless phone, and the like. A method using electromagnetic induction has been commonly used, in which a magnetic flux is generated when current is applied to one of the two adjacent coils, and the magnetic flux penetrates through the other coil to generate an electromotive force.

In the conventional wireless power supply, it has been unnecessary to finely regulate transmitting power. In the case of a non-contact IC card, because the power consumption is considerably small (a few tens of milliwatts), even if the transmission side transmits a certain amount of power and an unnecessary power is discarded on the reception side, wasted power is small and has therefore not been a problem. On the other hand, in the case of a cordless phone, because a secondary battery built in on the reception side is charged, power required for charging changes only slowly. Recently, there have been proposed techniques that, in such a manner that, for example, an electric vehicle can be charged while running, allow supply of power wirelessly during use of equipment, and if there is a secondary battery or capacitor, a necessary power can be instantaneously supplied from the secondary battery even when a sudden change in power consumption occurs. It therefore suffices that non-contact charging can be performed, and there has been no demand for wireless power supply that can respond to a rapid load fluctuation.

However, in the case of supplying power to information equipment, such as a large-capacity memory card, that is small-sized and requires a power of 1 w or more, it is desirable to regulate transmitting power in response to a sudden change in power consumption. This is because wasted power is excessively great if a redundant power is discarded on the reception side and a secondary battery or a sufficiently large capacitor cannot be loaded. In the case of a memory card, power consumption can even change by one digit within 0.1 milliseconds in response to a reading/writing operation of data. In order to keep power source voltage constant on the power reception side without wasted power, it is necessary to rapidly control transmitting power following the operating state of the equipment.

The transmitting power can be controlled by modulating the switching frequency of switching currents to flow through a coil on the transmission side (FM modulation) (refer to, for example, Non Patent Literature 1.), or by modulating the pulse width (PW modulation) (refer to, for example, Non Patent Literature 2.).

Because the power is transferred every switching, the higher the switching frequency, the higher speed the transmitting power can be controlled. Up until now, a few hundred kilohertz has often been used, but switching control using, for example, a few megahertz to 10-odd megahertz is desired.

However, available frequencies are limited by rules. Particularly in a high frequency band of 1 MHz or more, there are strict rules. For example, the International Telecommunication Union (ITU) assigns and limits frequency bands for exclusive use for industrial, scientific, and medical purposes other than wireless communications as high-frequency energy sources called ISM bands. For example, in the range of 13.553 MHz to 13.567 MHz which is one of the ISM bands, electromagnetic waves having a magnetic field strength of 40 dBuA/m may be irradiated at a spot 10 m away, but the magnetic field strength must be −8 dBuA/m or less outside the ISM band. In this case, because the range of frequency that is permitted as the ISM band is only 0.05% (±7 kHz) of a central frequency (13.56 MHz), there has been a problem that a range in which transmitting power can be regulated using FM modulation or PW modulation is narrow in the narrow frequency range.

Therefore, the present inventors have proposed a method, by an arrangement in which two transmission-side coils are provided in an overlapping manner, and magnetic fluxes generated by both coils are summed up to be passed through a receiving coil, for regulating power to be transferred to the reception side by changing the phases of transmitting currents to be applied to the respective transmitting coils (refer to Non Patent Literature 3.). Specifically, the transmission power is maximized when magnetic fluxes sent out by the two transmitting coils are superimposed with the same phase, the transmission power is minimized when both magnetic fluxes are superimposed with opposite phases, so that the transmitting power can be regulated by phasing without changing the switching frequency.

### CITATION LIST

### Non Patent Literature

[Non Patent Literature 1] Ping Si et al., “A Frequency Control Method for Regulating Wireless Power to Implantable Devices,” Trans. Biomedical Circuits and Systems, vol. 2, pp. 22-29, March 2008.
[Non Patent Literature 2] Wenzhen Fu et al., “Study on Frequency-tracking Wireless Power Transfer System by Resonant Coupling,” IPEMC, pp. 2658-2663, May 2009.
[Non Patent Literature 3] K. Tomita, R. Shinoda, T. Kuroda, and H. Ishikuro, “1 W 3.3V-to-16.3V Boosting Wireless Power Transfer Circuits with Vector Summing Power Controller,” IEEE Asian solid state circuit conference (A-SSCC' 11), Dig. Tech. Papers, pp. 177-180, November 2011.

### TECHNICAL PROBLEM

However, this system has had a problem that, when a transferring power is reduced, power flows from one transmitting coil to the other transmitting coil and a part thereof is lost, so that power efficiency cannot be increased.

In view of the above-described problems, it is an object of the present invention to provide a wireless power supply device with a high power conversion efficiency, with less unwanted radiation, and capable of rapidly changing supplying power.

### SOLUTION TO PROBLEM

A wireless power supply device according to a first aspect of the present invention comprises a power transmission-side resonance circuit that resonates at a predetermined resonant frequency and inductively couples with a power reception-side resonance circuit to supply power wirelessly; a switching circuit that excites the power transmission-side resonance circuit at a predetermined frequency; and a control circuit that controls supplying power by controlling excitation of the switching circuit selectively at a plurality of frequencies among the resonant frequency and subharmonic frequencies for which the resonant frequency is divided by an odd number.

A wireless power supply device according to a second aspect of the present invention comprises a power transmission-side resonance circuit that resonates at a predetermined resonant frequency and inductively couples with a power reception-side resonance circuit to supply power wirelessly; a switching circuit that excites the power transmission-side resonance circuit at a predetermined frequency; a control circuit that controls supplying power by controlling excitation of the switching circuit selectively at a plurality of frequencies among the resonant frequency and subharmonic frequencies for which the resonant frequency is divided by an odd number; and a power reception-side resonance circuit that resonates at the resonant frequency and inductively couples with the power transmission-side resonance circuit to be supplied with power wirelessly.

In a wireless power supply device according to a third aspect of the present invention, the control circuit selects the plurality of frequencies pseudo-randomly.

In a wireless power supply device according to a fourth aspect of the present invention, the control circuit selects the plurality of frequencies pseudo-randomly by ΔΣ modulation.

In a wireless power supply device according to a fifth aspect of the present invention, the control circuit receives information concerning necessary supplying power from a power reception-side circuit, and selects the plurality of frequencies according to the necessary supplying power.

### ADVANTAGEOUS EFFECTS OF INVENTION

A wireless power supply device according to the present invention has a high power conversion efficiency and less unwanted radiation, and is capable of rapidly changing supplying power.

### BRIEF DESCRIPTION OF DRAWINGS

FIG. 1 is a view depicting a configuration of a wireless power supply device according to Example 1 of the present invention.

FIGS. 2A to 2D are views depicting relationships between an excitation frequency and an excitation voltage.

FIGS. 3A to 3D are views depicting waveforms of a voltage that is applied to a resonance circuit and waveforms of a current that flows to the resonance circuit in the case of excitation at a resonant frequency.

FIGS. 4A to 4F are views (part 1) depicting voltage and current waveforms in the case of switching at a frequency that is ⅓ of the resonant frequency.

FIGS. 5G to 5L are views (part 2) depicting voltage and current waveforms in the case of switching at a frequency that is ⅓ of the resonant frequency.

FIGS. 6A and 6B are views depicting a principle of control of transmission power in Example 1.

FIGS. 7A and 7B are views depicting how to create subharmonics having duty ratios other than 50%.

FIG. 8 is a view depicting a current-frequency spectrum when a resonant frequency and its ⅓ subharmonic were switched by PWM modulation.

FIG. 9 is a view depicting a current-frequency spectrum when pseudo-random PWM modulation was used according to Example 2 of the present invention.

FIG. 10 is a view depicting a current-frequency spectrum when ΔΣ modulation according to Example 3 of the present invention was used.

FIG. 11 is a view depicting a current-frequency spectrum when bandpass ΔΣ modulation according to Example 4 of the present invention was used.

FIG. 12 is a view depicting a configuration of a wireless power supply device according to Example 5 of the present invention.

FIG. 13 is a view depicting an operating waveform actually measured in the configuration according to Example 5 of the present invention.

FIG. 14 is a view depicting a configuration of a wireless power supply device according to Example 6 of the present invention.

FIG. 15 is a graph representing the transmission power and efficiency when the ratio of the resonant frequency to the ⅓ subharmonic was changed.

FIG. 16 is a graph showing a result of a comparison between with and without ΔΣ modulation of changes in an unwanted radiation component when transmission power was changed.

FIGS. 17A and 17B are views depicting a modification of the configuration of resonance circuits of the present invention.

FIGS. 18A to 18C are views depicting other modifications of the configuration of a resonance circuit of the present invention.

FIG. 19 is a view showing still another modification of the configuration of the present invention.

### DESCRIPTION OF EMBODIMENTS

Hereinafter, modes for carrying out the present invention will be described in detail with reference to the accompanying drawings.

### EXAMPLE 1

FIG. 1 is a view depicting a configuration of a wireless power supply device according to Example 1 of the present invention. The wireless power supply device of the present Example 1 includes, on its power transmission side, a control circuit 10, a switching circuit 11, and a resonance circuit consisting of an inductor L1 and a capacitor C1, and includes, on its power reception side, a resonance circuit consisting of an inductor L2 and a capacitor C2, a rectifier 12, a capacitor C3, and an output load Z. The switching circuit 11 consists of a series circuit of a switch SW1 and a switch SW2, and by alternately turning on and off the switches, excites the resonance circuit of L1 and C1 at a predetermined frequency.

As a result of inductive coupling (a mutual inductance M) of the inductor L1 on the transmission side and the inductor L2 on the reception side, wireless power supply can be performed.

A resonant frequency fo is selected from, for example, the IMS bands. The resonant frequency fo is determined by the following:

fo=½π√{(L−M)C} (1)

The resonant frequency fo becomes approximately 13 MHz when

L=L1=L2=300 nH

M=150 nH

C=C1=C2=1.0 nF

are selected.

When the switching circuit is controlled at 13.56 MHz under above described conditions, power can be transferred at high efficiency. Also, noise generation can be suppressed.

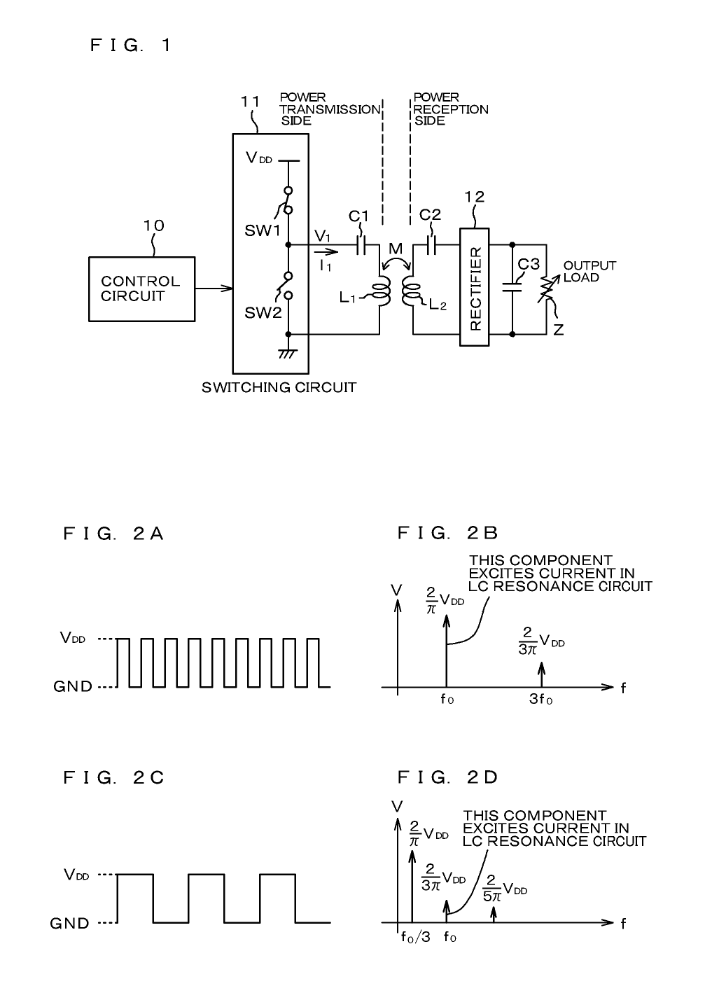

FIGS. 2A to 2D are views depicting relationships between an excitation frequency and an excitation voltage. FIGS. 2A and 2B depict a case where the resonance circuit is excited by rectangular waves of a voltage VDD of the resonant frequency fo. In this case, based on a Fourier expansion of the rectangular waves, the voltage amplitude of the component of fo being the fundamental frequency of the rectangular waves is expressed as 2 VDD/m, and the voltage amplitude of an n-th harmonic component is expressed as 2 VDD/nπ (n is an odd number). FIGS. 2C and 2D depict a case where the resonance circuit is excited by use of a subharmonic (fo/n; here, n=3) for which the resonant frequency fo is divided by an odd number. In this case, a smaller power than that when the resonant frequency fo is used can be supplied. Specifically, the voltage amplitude of the component of fo/n being the fundamental frequency of the rectangular waves is expressed as 2 VDD/π, and the voltage amplitude of an n-th harmonic component corresponding to the resonant frequency fo is expressed as 2 VDD/nπ. Only the component equivalent to the resonant frequency fo is supplied to the power reception side effectively through the resonance circuit, and other components are collected to the power source side due to impedance mismatching. Accordingly, using an n-th subharmonic allows reducing the voltage of a resonant frequency component to 1/n. When the load impedance is constant, the transmitting power is proportional to the second power of the voltage and can therefore be suppressed to 1/n². It is also possible to use a method of controlling the power source voltage VDD by a DC-DC converter or the like with the frequency fixed for regulation of the transmitting power, which however leads to an increase in the number of components to cause an increase in the mounting area and cost and deterioration in efficiency. In the present Example 1, power control is possible without excessively increasing the number of components (a frequency switching function and the like can be integrated).

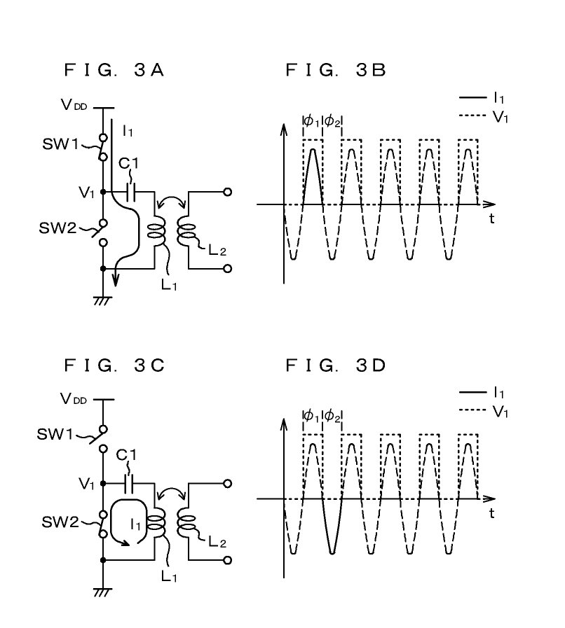

FIGS. 3A to 3D are views depicting waveforms of a voltage that is applied to a resonance circuit and waveforms of a current that flows to the resonance circuit in the case of excitation at a resonant frequency. First, when the switch SW2 is turned off and the switch SW1 is turned on (φ1), a current I1 begins to flow to the resonance circuit. The current I1 is maximized at a point in time of ¼ of the switching period, and due to a resonance effect, the current then begins to decrease and the current reaches 0 at a point in time of ½ of the switching period. Next, when the switch SW1 is turned off and the switch SW2 is turned on (φ2), the current begins to flow reversely and flows by way of the inductor L1, the capacitor C1, and the switch SW2 in this order. Thus performing switching at the resonant frequency allows making the current 0 at the timing where voltage is applied to the switches, so that loss can be suppressed (zero-current switching). Further, the current that flows through the inductor L1 has a sine wave shape free from a discontinuous point, so that an unwanted radiation component can be suppressed.

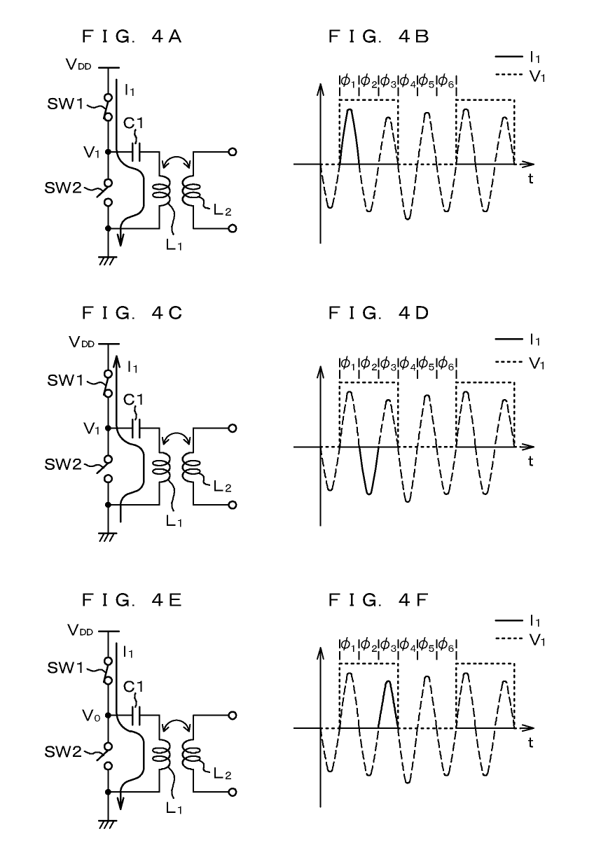

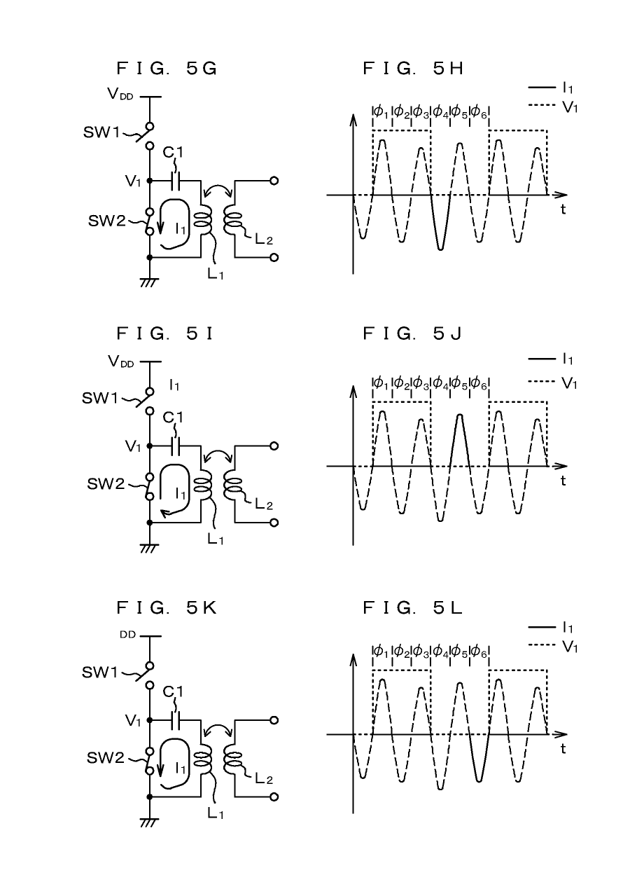

FIGS. 4A to 4F and FIGS. 5G to 5L are views depicting voltage and current waveforms in the case of switching at a frequency that is ⅓ of the resonant frequency. When the SW2 is turned off and the SW1 is turned on, similar to the foregoing, a current I1 begins to flow to the resonance circuit, and the current flows from the power source toward the inductor L1 for a period of ½ (φ1) of the resonance period, the current flows reversely toward the power source for the next ½ period (φ2) of the resonance period, and for the still next ½ period (φ3), the current again flows from the power source toward the inductor L1. Subsequently, when the SW1 is turned off and the SW2 is turned on (FIG. 5), for a period of 3/2 (φ4, φ5, and φ6) of the resonance period, the current circulates in a loop of the inductor L1, the capacitor C1, and the SW2 (the current direction changes every ½ period of the resonance period). Also in the case of switching at a frequency of ⅓ of the resonant frequency, the current that flows to the switches becomes 0 at the timing of switching of on/off of the switches, which enables effective switching with less unwanted radiation.

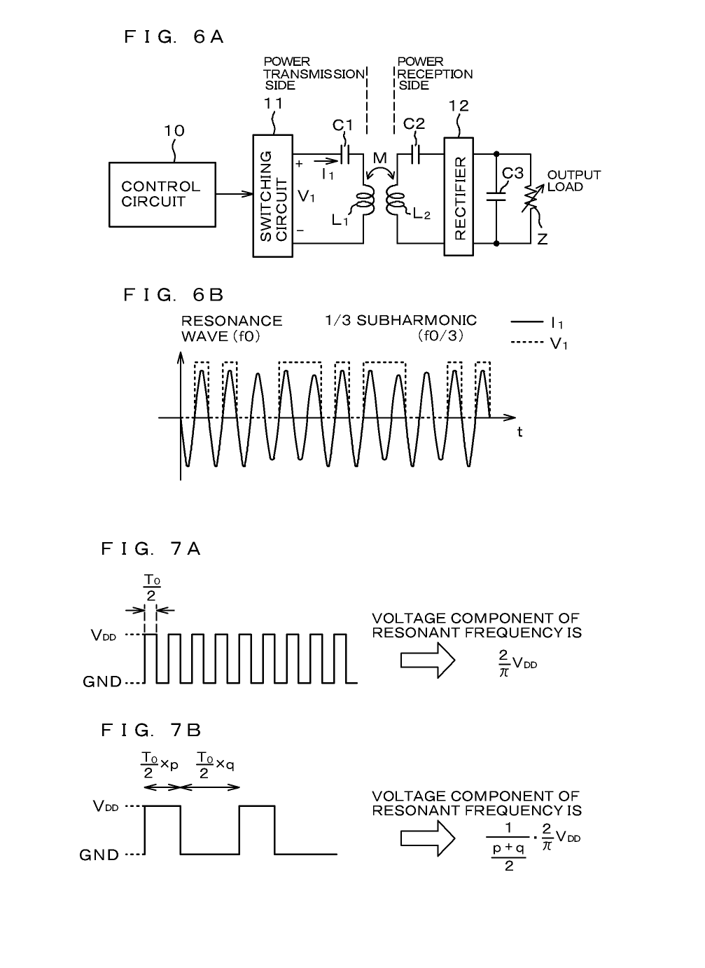

FIGS. 6A and 6B are views depicting a principle of control of transmission power in Example 1. Switching the switching frequency to a resonant frequency and its ⅓ subharmonic allows regulating transmitting power. The greater the ratio of use of the resonant frequency per unit time, the greater the transmission power, and the more the ratio of use of the ⅓ subharmonic increases, the more the transmission power decreases. Adjusting this ratio allows control of the transmission power.

(How to Create Wave with Arbitrary Integer-Divided Frequency by Changing Duty Ratio)

FIGS. 7A and 7B are views depicting how to create subharmonics having duty ratios other than 50%. Where the resonant frequency is provided as To, the time period where the switch SW1 is ON is provided as To/2×p and the time period where the switch SW2 is ON is provided as To/2×q. Here, p and q are odd numbers not less than 1. This wave has a period of To×(p+q)/2, and is equal to a signal of the resonant frequency divided by (p+q)/2 (the foregoing case of a 3-divided frequency is where p=q=3). A fundamental component of this signal has an amplitude of 2 VDDπ at a frequency of fo/{(p+q)/2}, and the voltage of a component at the resonant frequency fo has 2 VDD/{π(p+q)/2}. For example, where p=1 and q=3, a ½ subharmonic of the resonant frequency is provided. Using such a waveform allows producing an arbitrary integer-divided frequency that enables zero-current switching, without limitation to only odd number-divided frequencies. Specifically, changing the duty ratio to select the resonant frequency and the odd number-divided frequency allows producing an arbitrary integer-divided frequency. As a result, the degree of freedom in determining the frequency of the fundamental component increases, so that the application in which the present invention can be used increases even when available frequency bands are limited.

(Power Control Using Resonant Frequency and Two or More Subharmonics)

Further, power control may also be performed using a resonant frequency and its two or more subharmonics. Using more subharmonics can expand the regulatory range of power control, and makes it easy to prevent an unwanted radiation component from being generated at a specific frequency.

(Power Control by PWM Modulation)

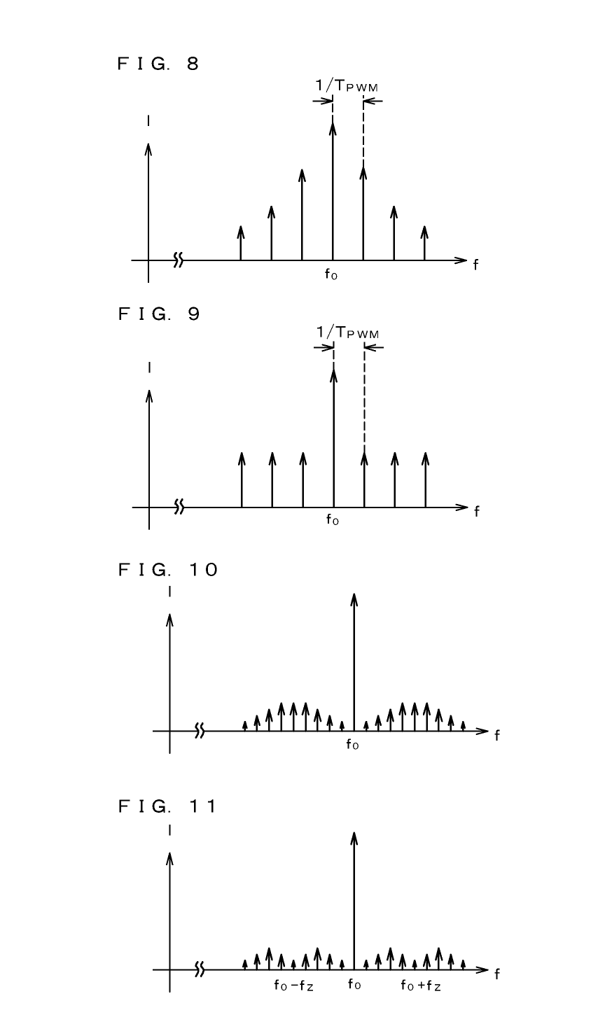

FIG. 8 is a view depicting a current-frequency spectrum when a resonant frequency and its ⅓ subharmonic were switched by PWM modulation. A power is supplied to the input of a PMW modulator, and the ratio of the time to use the resonant frequency fo and the time to use the ⅓ subharmonic is changed according to the intended power. Where the period of PWM is TPWM, the current that flows through the inductor L1 is modulated with a frequency interval of 1/TPWM centered on the resonant frequency.

### EXAMPLE 2

(Suppression of Spurious Component by Pseudo-Random PWM Conversion)

FIG. 9 is a view depicting a current-frequency spectrum when pseudo-random PWM modulation was used according to Example 2 of the present invention. The wireless power supply device of the present Example 2 sets the ratio of a resonant frequency and its ⅓ subharmonic to a predetermined value according to a supplying power, while using pseudo-random PWM modulation for switching. In Example 1, the current that flows through the inductor L1 shows a spectrum modulated with a frequency interval of 1/TPWM centered on the resonant frequency fo, and particularly, the power of a modulation component next to the resonant frequency fo is great. But using pseudo-random PWM can spread the spectrum, so that the modulation component near the resonant frequency can be suppressed.

### EXAMPLE 3

(Suppression of Spurious Component by ΔΣ Conversion)

FIG. 10 is a view depicting a current-frequency spectrum when ΔΣ modulation according to Example 3 of the present invention was used. The wireless power supply device of the present Example 3 sets the ratio of a resonant frequency and its ⅓ subharmonic to a predetermined value according to a supplying power, while performing switching in a pseudo-random manner to use ΔΣ conversion. Using ΔΣ conversion makes it possible to further remove the periodicity of a control signal, and makes it possible to suppress the intensity of individual spurious components.

### EXAMPLE 4

(Suppression of Spurious Component by Bandpass ΔΣ Conversion)

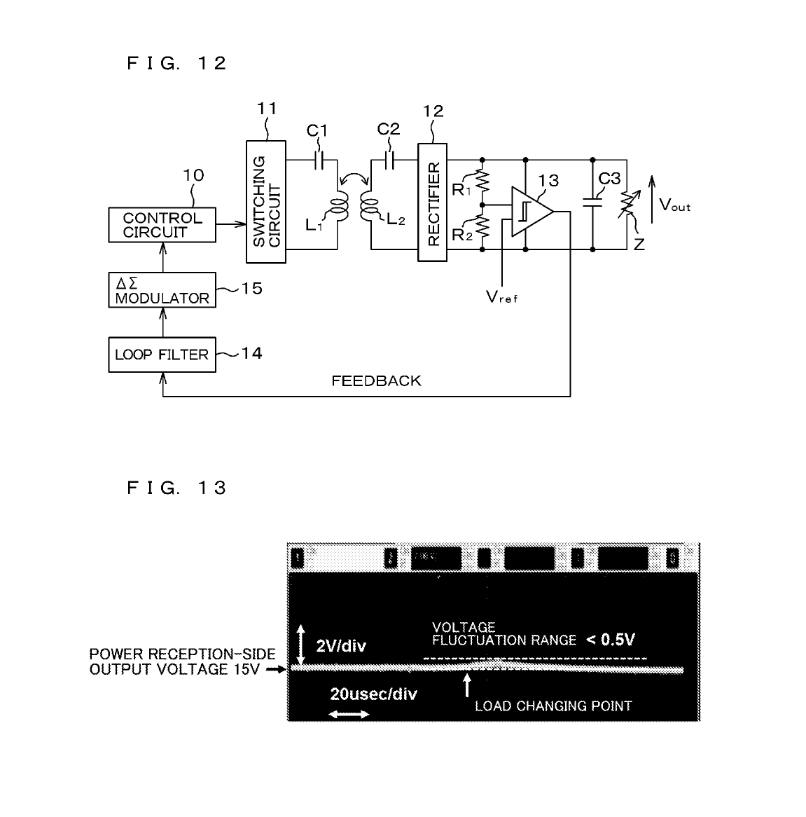

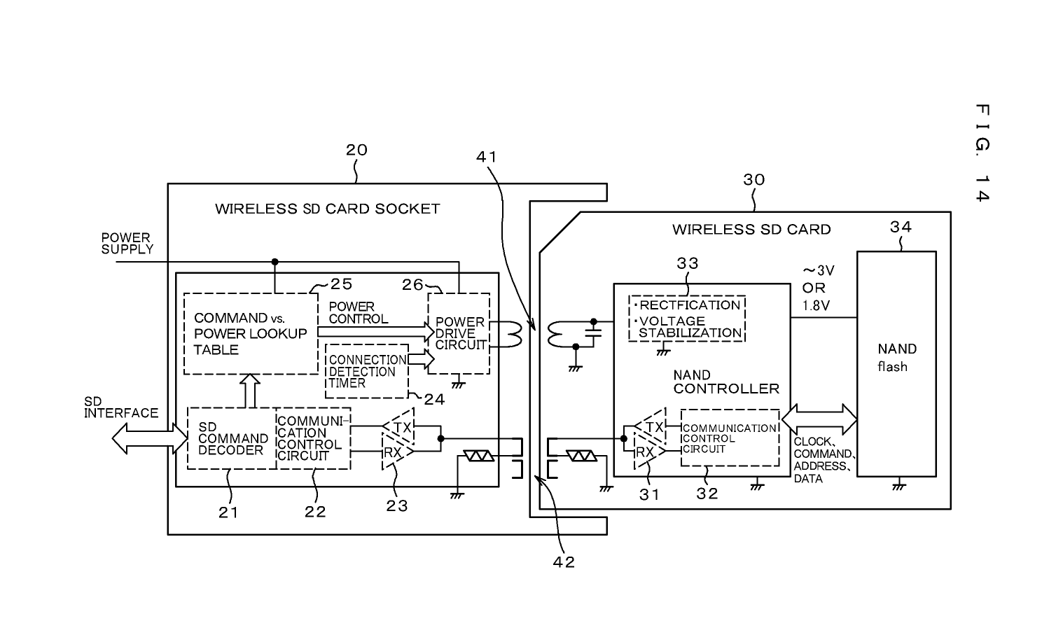

FIG. 11 is a view depicting a current-frequency spectrum when bandpass ΔΣ modulation according to Example 4 of the present invention was used. The wireless power supply device of the present Example 4 sets the ratio of a resonant frequency and its ⅓ subharmonic to a predetermined value according to a supplying power, while performing switching in a pseudo-random manner to use bandpass ΔΣ conversion. Adjusting the position of a zero point of bandpass ΔΣ conversion makes it possible to selectively suppress a spurious component in a specific frequency range. This can be used for such application as, for example, selectively suppressing a spurious component in a frequency band to be used for data transmission when power transmission and data transmission are simultaneously performed in different frequency bands.

### EXAMPLE 5

(Transmitting a Signal to Specify Power Transmission Amount from Power Reception Side to Power Transmission Side)

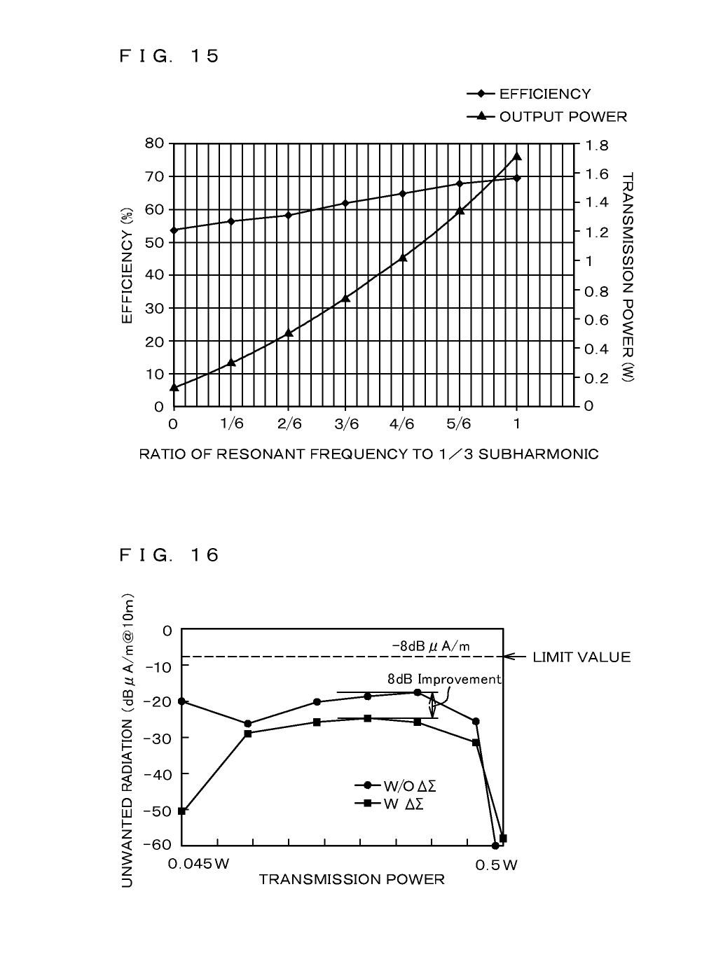

FIG. 12 is a view depicting a configuration of a wireless power supply device according to Example 5 of the present invention. The wireless power supply device of the present Example 5 feeds back a receiving status of the power reception side to the power transmission side to perform power control. On the power reception side, the wireless power supply device divides by series resistors R1 and R2 and monitors a voltage rectified by a rectifier 12, and make a comparison with a reference voltage Vref by a comparator 13, and transmits the result to the power transmission side by use of a data channel. On the power transmission side, the wireless power supply device regulates transmitting power by switching between a resonant frequency fo and its subharmonic, based on a fed-back signal, by a loop filter 14, a ΔΣ modulator 15, and a control circuit 10. In an application where no secondary battery or large capacity capacitor can be mounted on the power reception side, a high voltage is generated on the power reception side when a greater power than the load (power consumption) on the power reception side is transmitted, which spoils device reliability. Also, when the transmission power is smaller than the load on the power reception side, the voltage on the power reception side falls to result in a circuit malfunction. Indeed the power can be regulated by placing a regulator on the power reception side, but this case involves a power loss to lower efficiency. In contrast thereto, according to the present invention, because the minimum necessary power is always supplied with substantially no loss, the problem of device reliability and malfunction can be prevented at high efficiency.

FIG. 13 is a view depicting an operating waveform actually measured in the configuration according to Example 5 of the present invention. The figure depicts an output voltage response when load resistance Z was suddenly changed from 714Ω (315 mW) to 4.5 kΩ (50 mW) with an output voltage Vout=15V. Even at a load fluctuation of approximately one digit, a voltage change on the power reception side was suppressed within 3% (=0.45V), and voltage before the load fluctuation was recovered in approximately 30 usec.

### EXAMPLE 6

(Specifying Power Transmission Amount Based on Command on Power Transmission Side)

FIG. 14 is a view depicting a configuration of a wireless power supply device according to Example 6 of the present invention. The wireless power supply device of the present Example 6 shows an example of specifying a power transmission amount based on a command in terms of a case of supplying power to a wireless SD card. An SD card socket 20 being the power transmission side includes an SD command decoder 21, a communication control circuit 22, a transceiver 23, a connection detection timer 24, a command vs. power lookup table 25, a power drive circuit 26, a magnetic field coupler 41, and a directional coupler 42, and the SD card 30 being the power reception side includes a magnetic field coupler 41, a directional coupler 42, a transceiver 31, a communication control circuit 32, a rectifying and voltage stabilizing circuit 33, and a NAND flash memory 34. The SD command decoder 21 recognizes a command received via an SD interface, and transmits the command to the SD card 30 via the communication control circuit 22, the transceiver 23, and the directional coupler 42. Similarly, the command vs. power lookup table 25 specifies a power according to the command to the power drive circuit 26. In general, necessary power is different between writing and reading of memory. The power drive circuit 26, with a connection of the SD card 30 being detected by the connection detection timer 24, transmits the specified power to the SD card 30 via the magnetic field coupler 41. The SD card 30 receives the power via the magnetic field coupler 41, and obtains a necessary power source voltage by the rectifying and voltage stabilizing circuit 33. Also, the SD card 30 receives a command via the directional coupler 42, the transceiver 31, and the communication control circuit 32 to control the NAND flash memory 34.

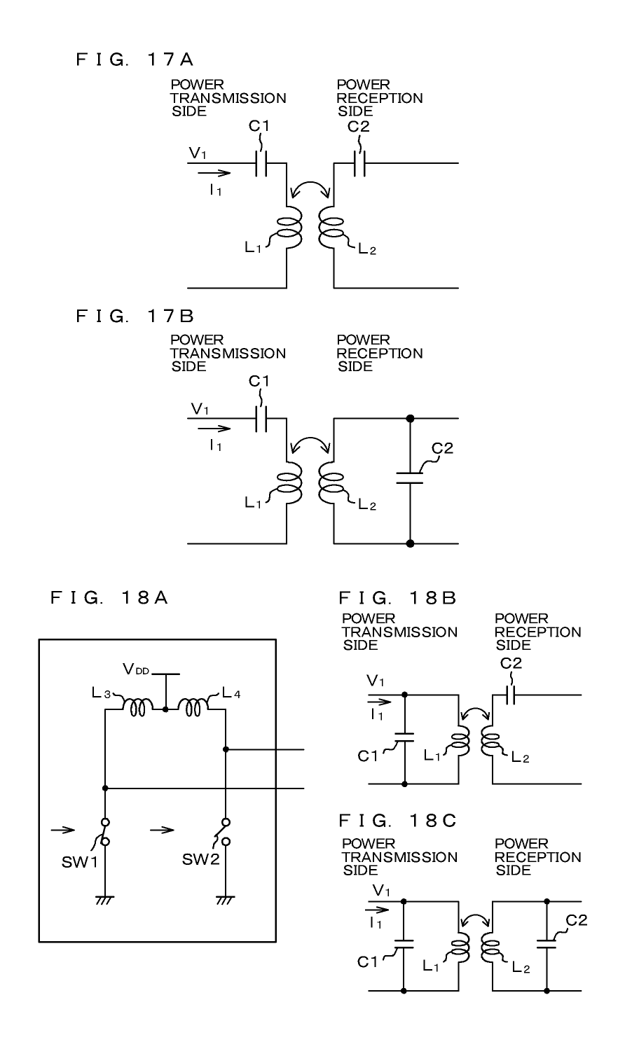

FIG. 15 is a graph representing the transmission power and efficiency when the ratio of the resonant frequency to the ⅓ subharmonic was changed. The horizontal axis represents the ratio of the resonant frequency to the ⅓ subharmonic where “0” is with only the ⅓ subharmonic, and “1” is with only the resonant frequency, the left vertical axis represents efficiency (%), and the right vertical axis represents transmission power (w). It can be understood that changing the ratio allows controlling the transmission power approximately one digit. Also, a fluctuation in efficiency in that case is suppressed to a little over 10%.

FIG. 16 is a graph showing a result of a comparison between with and without ΔΣ modulation of changes in the unwanted radiation component when transmission power was changed. The horizontal axis represents transmission power (w), and the vertical axis represents unwanted radiation (dBμA/m@10 m), specifically, a decibel notation of the magnetic field strength at a spot 10 m away. The unwanted radiation is below the limit value (ITU limit value: The magnetic field strength outside the ISM band is −8 dBuA/m or less) even without using ΔΣ modulation, but the unwanted radiation could be suppressed by approximately 8 dB by making the control signal random by use of ΔΣ modulation.

FIGS. 17A and 17B are views depicting a modification of the configuration of resonance circuits of the present invention. Examples of the series resonance circuit shown in FIG. 17A have been shown so far as the resonance circuits, but the power reception side may be the parallel resonance circuit shown in FIG. 17B.

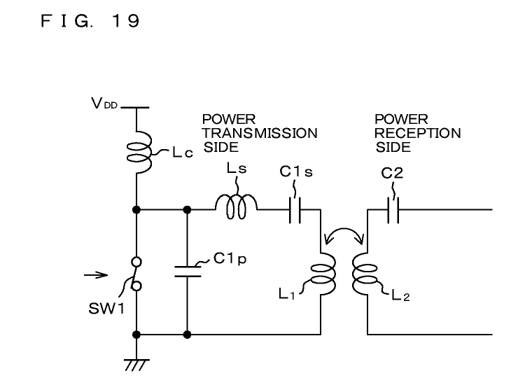

FIGS. 18A to 18C are views depicting other modifications of the configuration of resonance circuits of the present invention. As shown in FIG. 18B and FIG. 18C, a parallel resonance circuit may be used also for the power transmission side. In this case, as shown in FIG. 18A, the switching circuit is provided as a parallel circuit of a series circuit of an inductor L3 and the switch SW1 and a series circuit of an inductor L4 and the switch SW2.

FIG. 19 is a view showing still another modification of the configuration of the present invention. The present modification includes the switch SW1 by itself, and further inductors Lc and Ls and a capacitor C1p. The present modification is a circuit that performs so-called Class E operations.

The present invention is not limited to the above-described examples.

In short, it suffices with one that selectively excites a resonance circuit for magnetic field coupling by a resonant frequency and a plurality of frequencies among odd number-divided subharmonic frequencies of the resonant frequency.

Also, by setting the ratio of the plurality of frequencies to a predetermined value and randomly switching the frequencies, the occurrence of spurious components can be prevented.

The disclosure of Japanese Patent Application No. 2012-033264, filed on Feb. 17, 2012 including its specification, claims, and drawings, is incorporated herein by reference in its entirety.

All the publications, patents, and patent applications cited in the present specification are incorporated in the present specification by reference in their entirety.

### REFERENCE SIGNS LIST

41 Magnetic field coupler

42 Directional coupler

1. A wireless power supply device comprising:
a power transmission-side resonance circuit that resonates at a predetermined resonant frequency and inductively couples with a power reception-side resonance circuit to supply power wirelessly;
a switching circuit that excites the power transmission-side resonance circuit at a predetermined frequency; and
a control circuit that controls supplying power by controlling excitation of the switching circuit selectively at a plurality of frequencies among the resonant frequency and subharmonic frequencies for which the resonant frequency is divided by an odd number.

2. A wireless power supply device comprising:
a power transmission-side resonance circuit that resonates at a predetermined resonant frequency and inductively couples with a power reception-side resonance circuit to supply power wirelessly;
a switching circuit that excites the power transmission-side resonance circuit at a predetermined frequency;
a control circuit that controls supplying power by controlling excitation of the switching circuit selectively at a plurality of frequencies among the resonant frequency and subharmonic frequencies for which the resonant frequency is divided by an odd number; and
a power reception-side resonance circuit that resonates at the resonant frequency and inductively couples with the power transmission-side resonance circuit to be supplied with power wirelessly.

3. The wireless power supply device according to claim 1, wherein the control circuit selects the plurality of frequencies pseudo-randomly.

4. The wireless power supply device according to claim 3, wherein the control circuit selects the plurality of frequencies pseudo-randomly by ΔΣ modulation.

5. The wireless power supply device according to claim 1, wherein the control circuit receives information concerning necessary supplying power from a power reception-side circuit, and selects the plurality of frequencies according to the necessary supplying power.
